(19) United States
(12) Patent Application Publication
(10) Pub. No.: US 2016/0253680 A1
(43) Pub. Date: Sep. 1, 2016

(54) REAL-TIME INTER AND INTRA OUTLET TRENDING

(71) Applicant: NCR Corporation, Duluth, GA (US)

(72) Inventors: Steven Jarrett Giera, Dacula, GA (US); John DeSetto, Cumming, GA (US); Joel Aaron Miller, Atlanta, GA (US)

(21) Appl. No.: 14/632,197

(22) Filed: Feb. 26, 2015

(51) Int. Cl. G06Q 30/02; G06F 17/30

(52) U.S. Cl. CPC G06Q 30/0201; G06F 17/30312; G06F 17/30864; G06F 17/30525

(57) ABSTRACT

Various embodiments herein each include at least one of systems, devices, methods, and software for real-time inter and intra outlet trending, such as with regard to sales trends within one or more stores or departments. One method embodiment includes storing a product group definition identifying at least one product for monitoring and receiving, via a network, and storing, in a database, product sales data including data identifying a store and time and date of each respective sale. This method further includes receiving, from a requestor via a network, a request for a sales report dataset with regard to the product group and generating and transmitting, via the network to the requestor, the requested sales report dataset.

### BACKGROUND INFORMATION

Retailers frequently run a promotion on a specific item or group of items with the goal of driving floor traffic. However, current reporting mechanisms do not provide real-time data about how individual stores are performing. Without real-time data and reporting, issues cannot be identified and corrective action cannot be taken until the period report arrives. Similarly, when an individual store is over performing, rapid identification of that store may be beneficial as the store can be investigated to identify what is leading to the high performance. The result is lost sales and learning opportunities.

### SUMMARY

Various embodiments herein each include at least one of systems, devices, methods, and software for real-time inter and intra outlet trending, such as with regard to sales trends within one or more stores or departments.

One method embodiment includes storing a product group definition identifying at least one product for monitoring and receiving, via a network, and storing, in a database, product sales data including data identifying a store and time and date of each respective sale. This method further includes receiving, from a requestor via a network, a request for a sales report dataset with regard to the product group and generating and transmitting, via the network to the requestor, the requested sales report dataset. In this embodiment, the method may be performed by a server process that receives store sales data from one or more stores via a network and the requestor may be an app that executes on a mobile device or is accessed via a web browser.

Another method embodiment includes receiving, from a requestor via a network, a request for a sales report dataset with regard to a product group definition stored in a database. This method may then retrieve, from a database, product sales data for a current period for products of the identified product group definition to form a sales report dataset. The method then transmits, via the network to the requestor, the requested sales report dataset.

A further embodiment is in the form of a system. The system of this embodiment includes at least one processor, at least one network interface device, and at least one memory device, including instructions stored thereon that, when executed on the at least one processor, cause the processor to perform data processing activities. The data processing activities may include receiving, from a requestor via the at least one network interface device, a request for a sales report dataset with regard to a product group definition stored in a database. The data processing activities may further include retrieving, from a database, product sales data for a current period for products of the identified product group definition to form a sales report dataset. The data processing activities in such embodiments also include transmitting, via the at least one network interface device to the requestor, the requested sales report dataset.

These and other embodiments are detailed below.

### BRIEF DESCRIPTION OF THE DRAWINGS

FIG. 1 is a logical block diagram of a system architecture, according to an example embodiment.

FIG. 2 is a user interface illustration, according to an example embodiment.

FIG. 3 is a user interface illustration, according to an example embodiment.

FIG. 4 is a user interface illustration, according to an example embodiment.

FIG. 5 is a block flow diagram of a method, according to an example embodiment.

FIG. 6 is a block diagram of a computing device, according to an example embodiment.

### DETAILED DESCRIPTION

Various embodiments herein each include at least one of systems, devices, methods, and software for real-time inter and intra outlet trending, such as with regard to sales trends within one or more stores or departments. In some embodiments, sales data is uploaded over a network to a cloud data processing center. This data is then subjected to analytics processing. The analytics processing may execute on the data immediately, periodically, or upon request for a particular analytic view of all or a portion of the data. For example, a manager responsible for sales of particular products, product types, a department, and the like may access the data via a mobile device app to obtain a real-time view of product or product group sales activity for a particular store, a department in the store, many stores, and the like. As a promotion is typically time-limited, rapid identification of an issue can be important to the success of the promotion. Similarly, rapid identification of stores where there are high sales provides an opportunity to investigate what might be causing the high sales. By providing a real-time view of sales activity, including cross-store sales activity views, trends, issues, and opportunities may be rapidly identified. For example, retailers frequently run promotions on items or groups of items with the goal of driving floor traffic and increasing sales. By monitoring sales activity during the promotion in real-time, success of the promotion may be viewed. When success is not as expected, or one store is underperforming in view of other stores, such as by viewing actual and forecasted promotion sales versus previous sales or across a plurality of stores, potential issues and opportunities may be identified and investigated, such as to ensure shelves are stocked, signage is proper, sales personnel are properly informed and trained, and the like.

One embodiment, viewed at a high-level, includes a data processing center, which can be considered part of “the cloud” in modern parlance. The data processing center includes one or more servers that may be considered a backend system that stores and accesses data in a database. The backend system includes analytics processes that execute at various times to generate data views from data stored in the database. The database stores data including sales data representative of sales transactions, including products sold, at stores. The sales data is received into the data processing center and stored in the database either as sales are made, periodically (e.g., every 5 minutes, once an hour, etc.), or otherwise. The sales data may be received from Point-Of-Sale (POS) terminals, a store server process that aggregates sales data, or otherwise. The data may be pushed from the stores or pulled by a process in the data processing center as may execute on the backend system. The analytics processes may then execute upon the sales data stored in the database in view of product item groups configured and stored in the backend system that identify one or more products, the sales of which are to be monitored and area within which the sales are to be monitored (e.g., for a particular store, a group of stores, all stores, etc.). The analytics processes may execute upon receipt of new store data, periodically (e.g., once an hour), or upon receipt of an analytic data view request, such as from an app that executes on a mobile device of a responsible manager. The request may identify the relevant product group and the report may be generated and provided either as a preformatted, viewable dataset or as a dataset that is viewable within a user interface of the mobile device app. The dataset may include data of actual sales for a current period as well as a forecast of future sales, data of sales from one or more previous periods, and the like. The dataset may then be presented within the mobile device app. In other embodiments, the user may be utilizing a thin or thick client app that executes on a personal computer or other computing device or via browser-based app that executes on one or both of the backend system and a web host to provide this functionality on various device platform types within a web browser application.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

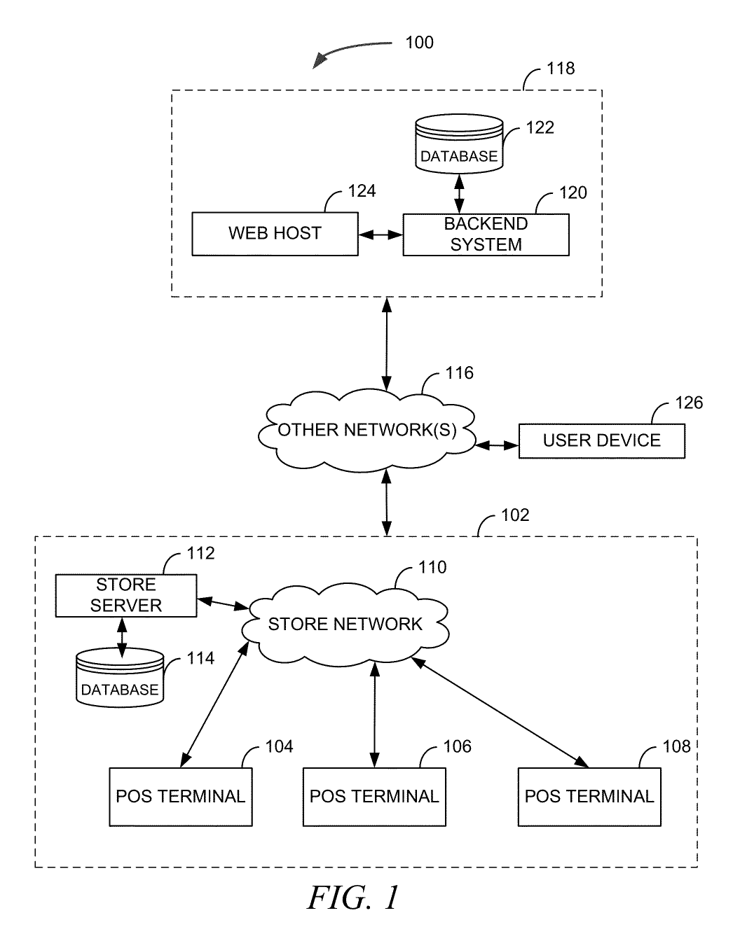

FIG. 1 is a logical block diagram of a system 100 architecture, according to an example embodiment. The system 100 is an example of a computing environment within which various embodiments may be implemented. The system 100 architecture is provided as only one example architecture on which some embodiments may be implemented. Other architectures may be utilized in other embodiments.

The system 100 includes a store 102 and a remote data processing center 118. The remote data processing center, in some embodiments, may be a corporate or regional data processing center of an entity that operates the store 102. In other embodiments, the data processing center 118 may be operated by an entity providing data analytics services, such as real-time inter and intra outlet trending services with regard to data received from stores 102 over one or more other networks 116. Thus, although only a single store 102 is illustrated, in various embodiments there may be many stores 102.

The store 102, as illustrated, includes three POS terminals (104, 106, 108 connected to a store network 110. The store 102 also includes a store server 112 that may include a database 114 thereon or as may otherwise be accessible via the store network 110. Although three POS terminals 104, 106, 108 are illustrated, the store 102 may include fewer or greater numbers of POS terminals. The POS terminals 104, 106, 108 may include one or a combination of various terminal types. For example, the POS terminals 104, 106, 108 may include standard cashier operated POS terminals, self-checkout terminals where a clerk attending to one or more of such terminals may be called to provide age verification input, a mobile device terminal (e.g., a POS app that executes on a mobile telephone, computer, or tablet), and the like. Generally speaking, the POS terminals 104, 106, 108 are a form of computing device that executes software to process purchase transactions, receive age verification input with regard thereto, and to locally store or provide data with regard to processed purchase transactions to at least one computing system, such as a store server 112 and a backend system 120, such that real-time inter and intra outlet trending services can be performed with regard to the transaction data, in particular with regard to products purchased within transactions conducted on the POS terminals 104, 106, 108.

The store 102 may also include a store server 112 in some embodiments. The store server 112 may receive transaction data from the POS terminals 104, 106, 108 including a representation of purchased products. The store server 112 may then store the received data to a database 114 or the POS terminals 104, 106, 108 may instead store such data directly to the database 114 via the store network 110. Regardless of how the data reaches the database 114, in some embodiments, an analytics process executes against the transaction data including the data representative of purchased products in view of product item groups to generate various data views of sales data during a current period, past periods, and additional forecasted sales. Some embodiments may further include providing alerts based on alert conditions defined within one or more product item groups.

However, not all embodiments will include a store server 112 and database 114 within the store 102. In other embodiments where the store 102 does not include a store server 112 and database 114, the transaction data may instead be provided by the POS terminals 104, 106, 108 to the backend system 120 and database 122 located in a data processing center 118 accessible via one or more of the store network 110 and one or more other networks 116. The one or more other networks 116 may include one or more of a virtual private network, a wide area network, the Internet, a network operated by a wireless service provider, dedicated and leased networks, and the like. Regardless of the network and network types over which the data may be provided to the backend system 120 and database 122, the data may be provided from the POS terminals 104, 106, 108 in either push or pull types of arrangements. Similar to the store server 112, the backend system 120 includes an analytics process that executes thereon against the transaction data including the data representative purchased products in view of product item groups to generate various data views of sales data during a current period, past periods, and additional forecasted sales. Some embodiments may further include providing alerts based on alert conditions defined within one or more product item groups. Note that in some embodiments, an analytics process may execute on more than one of the store server 112, the backend system 120, and one or more of the POS terminals 104, 106, 108.

Regardless of which of the store server 112, the backend system 120, and one or more of the POS terminals 104, 106, 108 on which an analytics process executes, the analytics process executes to retrieve various items of transaction data including representations of dates and times of transactions and purchased products to generate datasets from which graphical various data detail views of sales data may be generated, to identify trends and anomalies therein with regard to stores or departments, a group of stores, and a company as a whole. Such trends and anomalies may include declines in sales from a previous period, variance from a forecast or other predicted sales level, a current period sales volume plus a forecasted sale amount varying from an expectation, a sudden decrease or increase in sales volume, and the like. Various analytics algorithms may be defined and configured in different embodiments based on operator requirements, experience, promotion-types, and the like.

When a potential issue is detected, an alert may be generated in some embodiments. The purpose of such an alert may be to notify one or more people of the potential issue so they know to investigate. An alert may be communicated to each of the one or more people via an email, a text message, data presented in a user interface of a computer or mobile device application or app, such as may be present or accessible on a user device 126. For example, the user device 126 may be a mobile telephone that includes an app thereon that presents analytical data views of data including data views generated by the backend system 120 in response to a request from an app that executes on the user device 126 for a real-time view of sales activity with regard to a particular product item group. The analytics process upon identification of a potential issue may then generate a provide an alert message to the user device 126 of a responsible manager via one or more of the other networks 116 in the form of one or both of an email and text message that may be received and presented by the user device 126. The alert may also or alternatively be provided in a mobile device app user interface, such as a dashboard view, accessible by the user device 126 from the backend system and database via a web host 124.

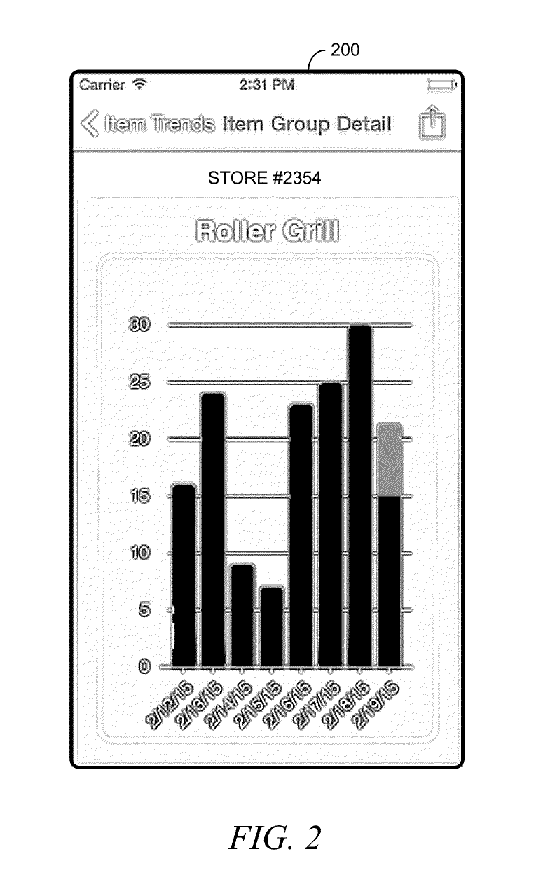

FIG. 2 is a user interface 200 illustration, according to an example embodiment. The user interface 200 illustrates the presentation of a sales report dataset with regard to a product group for sales at a store (i.e., “STORE #2354”). The sales report dataset is provided by an analytics process, such as may execute on the backend system 120 of FIG. 1, for the defined product item group “ROLLER GRILL” for the dates Feb. 12, 2015 through Feb. 19, 2015. The sales report dataset is requested and received by an app that executes on a user device, such as the user device 126 of FIG. 1. In some embodiments, the user interface 200 is a user interface defined within the app to be populated with the received sale report dataset.

The user interface 200 shows actual sales in black for each of the dates Feb. 12, 2015 through Feb. 19, 2015 and additional forecasted sales in grey on Feb. 19, 2015. The data illustrated within the user interface 200 shows higher sales and forecasted sales on the last four days of the illustrated period as compared to the first four days of the illustrated period. If the products of the ROLLER GRILL product item group are the subject of a current promotion, that may be as expected. However, note that the actual and forecasted sales data for Feb. 19, 2015 indicate a decline in sales compared to the previous four days. This may indicate an issue with regard to the promotion. This may prompt a user of the user device within which the user interface 200 is presented to investigate. This may reveal a signage issue at the product location within store STORE #2354, such as a sign advertising the promotion with regard to products of the ROLLER GRILL product item group may have been removed. As the sales report dataset is reflective of actual or near real-time data, the issue may be identified quickly and address rapidly to help ensure desired sales effects of the promotion are realized.

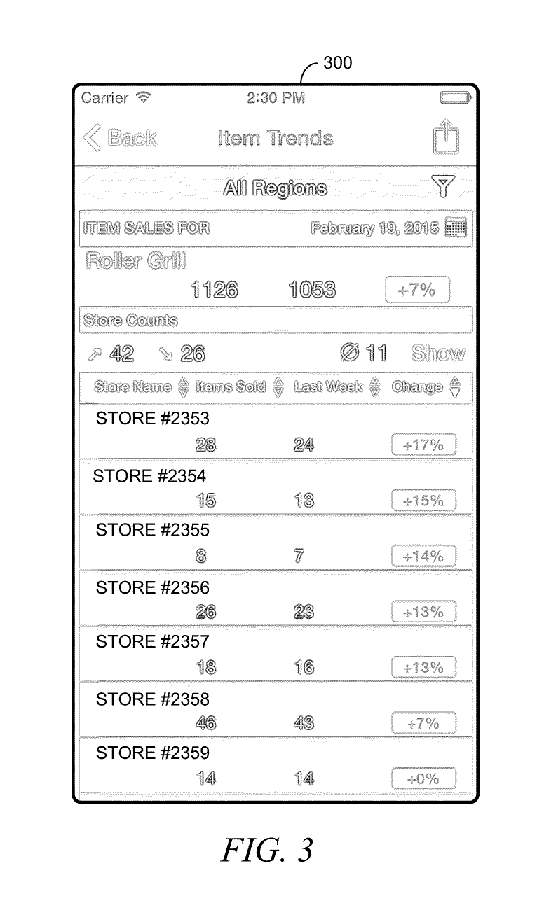

FIG. 3 is a user interface 300 illustration, according to an example embodiment. The user interface 300 may be another user interface of a mobile device app, such as may also be presented on the user device 126 of FIG. 1. The user interface 300, rather than providing a view of a sales report dataset for only a single store instead provides a view of a sales report dataset for a plurality of stores. This user interface 300 allows the viewing user to identify and compare sales trends across multiple stores to identify potential issues and outliers with regard to high sales. Both the underperformers and the over-performers can then be investigated to identify causes of lower sales and contributors to higher sales. In some embodiments, a user may select a stored listed in the user interface 300 to view more sales data details with regard to the store. Such a selection, in some embodiment, may cause the app to present the user interface 200 of FIG. 2.

The user interview 300, as can be readily seen, allows the viewer to make cross-store comparisons of sales activity. From the presented view in the user interface 300, the user can quickly see that STORE #2359 is severely under performing as its sales change percentage is 0%. The user is likely to investigate the reasons therefore. Similarly, STORE #2353 has a highest change in sales of 17%. The user may choose to investigate to learn what might be contributing to such a high sales increase. Through use of such embodiments, users and organizations are able to not only rapidly spot potential issues to allow quick mitigation thereof, but also gain wisdom from the sales related activities at one store location that is likely to contribute to success at other locations. Note however, that not all disparities between store sales activity is indicative of in-store activity. For example, if the dataset presented in the user interface 300 is with regard to a product item group for snow removal equipment, the locations of the stores and weather at their locations are likely the root cause for the varied sales activity. This may be true where there is a lot of snow during a current period at STORE # 2353 and no snow at STORE #2359. Thus, in some embodiments, the user interface 300 may include various options for presenting and sorting the data presented therein. For example, rather than sorting the data based on store number or change in store sales, the data may instead be sorted by locations of the stores or one or more other data items.

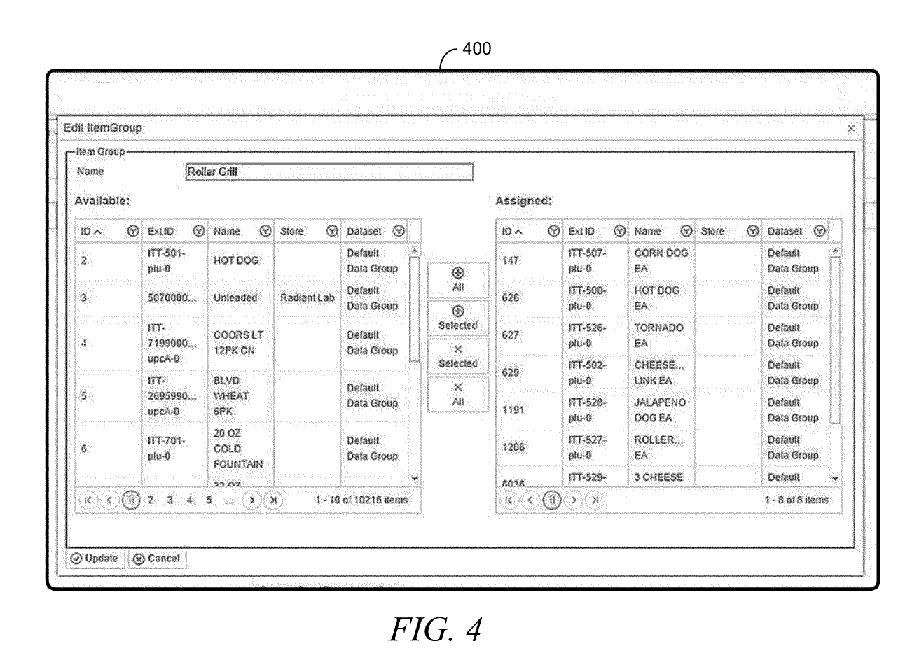

FIG. 4 is a user interface 400 illustration, according to an example embodiment. The user interface 400 is an illustration of a listing of a product item group. This product item group is the “ROLLER GRILL” product item group for which in the user interfaces 200 and 300 is presented. The details of the ROLLER GRILL product item group include a listing of a plurality of products items that can be assigned to the product item group on the left-hand side and a plurality of product items that are assigned on the right-hand side. In some embodiments, additional details may be defined with regard to a product item group. Some such additional details may include an active period for the product item group, as may be assigned based on active dates for a promotion and, when applicable, when products of the product group are and are not available for sale. Other additional details that may be added to a product item group definition is one or more data viewing formats, a unit of sales measure (product count, currency amount, pounds, grams, minutes, etc.), a department, store, or group of stores for which data is to be considered, and the like.

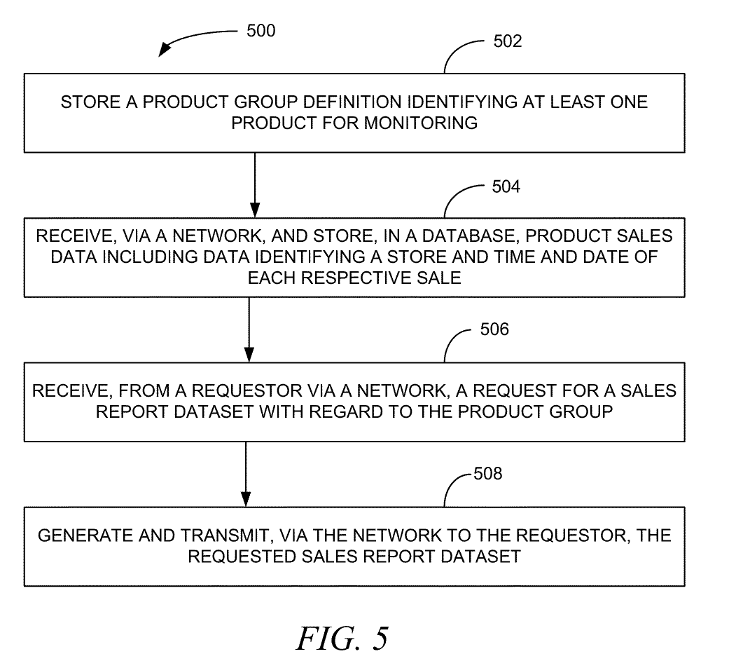

FIG. 5 is a block flow diagram of a method 500, according to an example embodiment. The method 500 is an example of a method that may be performed in generating a sales report dataset, such as by an analytics process that may execute on one or more of the backend system 120, store server 112, and a POS terminal 104, 106, 108 of FIG. 1.

The method 500 includes storing 502 a product group definition identifying at least one product for monitoring and receiving 504, via a network, and storing, in a database, product sales data including data identifying a store and time and date of each respective sale. The method 500 then receives 506, from a requestor via a network, a request for a sales report dataset with regard to the product group. The method 500 processes the received 506 request by generating and transmitting 508, via the network to the requestor, the requested sales report dataset.

In some embodiments, generating the sales report dataset includes retrieving at least a portion of the product group definition, such as data defining a product item group, and retrieving, from the database, product sales data for a recent period for each of the at least one products identified in the product definition. The product sales data retrieved typically includes at least one unit of sales measure, which may be a default sales measure or as otherwise configured, such as in a product item group. In some embodiments, the product group definition further identifies at least one of a store and department. In such embodiments, the retrieving of the product sales data retrieves the product sales data with regard to only the at least one of the store and department identified in the product group definition.

In some embodiments, a received 506 request for a sales report dataset identifies a template within which the sales report dataset it to be presented on a requestor computing device, such as a template as utilized in generating the user interface 200 of FIG. 2.

In a further embodiment of the method 500 generating 508 the requested sales report dataset further includes, when a current sales day is not complete, forecasting additional sales for the current day. The forecasting may include retrieving at least one average unit of sales measure from the sales data stored in the database for each of the at least one products identified in the product group definition for each of a number of most recent equivalent weekdays based on a time of data of the product sales. This time of day is where the sales were made at a time of day greater than a current time of day. The retrieved at least one average unit of sale measure in such embodiments is a forecast of additional sales for the current sales day. Other forecasting methodologies may be utilized in other embodiments.

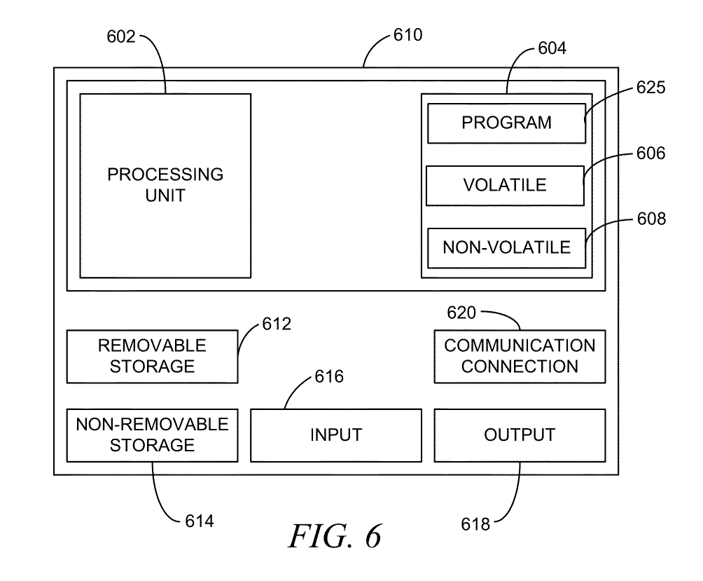

FIG. 6 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 610, may include a processing unit 602, memory 604, removable storage 612, and non-removable storage 614. Although the example computing device is illustrated and described as computer 610, the computing device may be in different forms in different embodiments. For example, the computing device may instead be a smartphone, a tablet, smartwatch, or other computing device including the same or similar elements as illustrated and described with regard to FIG. 6. Devices such as smartphones, tablets, and smartwatches are generally collectively referred to as mobile devices. An example of such a computing device according to some embodiments is the user device 126 illustrated and described with regard to FIG. 1. Further, although the various data storage elements are illustrated as part of the computer 610, the storage may also or alternatively include cloud-based storage accessible via a network, such as the Internet.

Returning to the computer 610, memory 604 may include volatile memory 606 and non-volatile memory 608. Computer 610 may include—or have access to a computing environment that includes a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 610 may include or have access to a computing environment that includes input 616, output 618, and a communication connection 620. The input 616 may include one or more of a touchscreen, touchpad, mouse, keyboard, camera, one or more device-specific buttons, one or more sensors integrated within or coupled via wired or wireless data connections to the computer 610, and other input devices. The computer 610 may operate in a networked environment using a communication connection 620 to connect to one or more remote computers, such as database servers, web servers, and other computing device. An example remote computer may include a personal computer (PC), server, router, network PC, a peer device or other common network node, or the like. The communication connection 620 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 620 may also or alternatively include a transceiver device, such as a BLUETOOTH® device that enables the computer 610 to wirelessly receive data from and transmit data to other BLUETOOTH® devices.

Computer-readable instructions stored on a computer-readable medium are executable by the processing unit 602 of the computer 610. A hard drive (magnetic disk or solid state), CD-ROM, and RAM are some examples of articles including a non-transitory computer-readable medium. For example, various computer programs 625 or apps, such as one or more applications and modules implementing one or more of the methods illustrated and described herein or an app or application that executes on a mobile device or is accessible via a web browser, may be stored on a non-transitory computer-readable medium.

Another embodiment is in the form of a system. The system of this embodiment includes at least one processor, at least one network interface device, and at least one memory device, including instructions stored thereon that, when executed on the at least one processor, cause the processor to perform data processing activities. The data processing activities may include receiving, from a requestor via the at least one network interface device, a request for a sales report dataset with regard to a product group definition stored in a database. The data processing activities may further include retrieving, from a database, product sales data for a current period for products of the identified product group definition to form a sales report dataset. The data processing activities in such embodiments also include transmitting, via the at least one network interface device to the requestor, the requested sales report dataset.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
storing a product group definition identifying at least one product for monitoring;
receiving, via a network, and storing, in a database, product sales data including data identifying a store and time and date of each respective sale;
receiving, from a requestor via a network, a request for a sales report dataset with regard to the product group; and
generating and transmitting, via the network to the requestor, the requested sales report dataset.

2. The method of claim 1, wherein generating the sales report dataset includes:
retrieving at least a portion of the product group definition; and
retrieving, from the database, product sales data for a recent period for each of the at least one products identified in the product definition.

3. The method of claim 2, wherein the product sales data retrieved includes at least one unit of sales measure.

4. The method of claim 3, wherein:
the request for the sales report dataset identifies a template within which the sales report dataset it to be presented on a requestor computing device.

5. The method of claim 4, wherein the product group definition further identifies at least one of a store and department, and the retrieving of the product sales data retrieves the product sales data with regard to only the at least one of the store and department identified in the product group definition.

6. The method of claim 5, wherein generating the requested sales report dataset further includes:
when a current sales day is not complete, retrieving at least one average unit of sales measure from the sales data stored in the database for each of the at least one products identified in the product group definition for each of a number of most recent equivalent weekdays where the product sales were made at a time of day greater than a current time of day, the retrieved at least one average unit of sale measure being a forecast of additional sales for the current sales day.

7. The method of claim 5, wherein at least one of a store and department of a product group definition identifies a plurality of stores.

8. The method of claim 7, wherein generating the requested sales report dataset further includes retrieving the product sales data for each of the plurality of stores identified in the product group definition.

9. The method of claim 1, wherein generating the requested sales report dataset, when the request is received from a web-browser requestor, further includes encoding the dataset in a format renderable within a web browser.

10. A method comprising:
receiving, from a requestor via a network, a request for a sales report dataset with regard to a product group definition stored in a database; and
retrieving, from a database, product sales data for a current period for products of the identified product group definition to form a sales report dataset; and
transmitting, via the network to the requestor, the requested sales report dataset.

11. The method of claim 10, wherein retrieving the product sales data includes calculating at least one unit of sales measure with regard to the products of the product group definition as a whole.

12. The method of claim 11, wherein the product group definition further identifies at least one of a store and department, and the retrieving of the product sales data retrieves the product sales data with regard to only the at least one of the store and department identified in the product group definition.

13. The method of claim 12, wherein the product sales data further includes:
when the current sales period is not complete, retrieving at least one average unit of sales measure from the sales data stored in the database for each of the at least one products identified in the product group definition for each of a number of most recent previous sales periods where the product sales were made at point in the respective sales periods greater than a current point in the current sales period, the retrieved at least one average unit of sale measure being a forecast of additional sales for the current sales period.

14. The method of claim 13, wherein the sales period is a defined within the product group definition.

15. The method of claim 12, wherein:
the at least one of a store and department of a product group definition identifies a plurality of stores; and
retrieving the product sales data to form the sales report dataset includes retrieving the product sales data for each of the plurality of stores identified in the product group definition.

16. A system comprising:
at least one processor;
at least one network interface device; and
at least one memory device, including instructions that, when executed on the at least one processor, cause the processor to perform data processing activities comprising:
receiving, from a requestor via the at least one network interface device, a request for a sales report dataset with regard to a product group definition stored in a database; and
retrieving, from a database, product sales data for a current period for products of the identified product group definition to form a sales report dataset; and
transmitting, via the at least one network interface device to the requestor, the requested sales report dataset.

17. The system of claim 16, wherein retrieving the product sales data includes calculating at least one unit of sales measure with regard to the products of the product group definition as a whole.

18. The system of claim 17, wherein the product group definition further identifies at least one of a store and department, and the retrieving of the product sales data retrieves the product sales data with regard to only the at least one of the store and department identified in the product group definition.

19. The system of claim 18, wherein the product sales data further includes:
when the current sales period is not complete, retrieving at least one average unit of sales measure from the sales data stored in the database for each of the at least one products identified in the product group definition for each of a number of most recent previous sales periods where the product sales were made at point in the respective sales periods greater than a current point in the current sales period, the retrieved at least one average unit of sale measure being a forecast of additional sales for the current sales period.

20. The system of claim 18, wherein:
the at least one of a store and department of a product group definition identifies a plurality of stores; and
retrieving the product sales data to form the sales report dataset includes retrieving the product sales data for each of the plurality of stores identified in the product group definition.
